(19) United States
(12) Patent Application Publication
(10) Pub. No.: US 2016/0140601 A1
(43) Pub. Date: May 19, 2016

(54) ADVERTISEMENT IMPRESSIONS OF RECOMMENDER FOR NETWORK DIFFUSION

(71) Applicant: BANK OF AMERICA CORPORATION, Charlotte, NC (US)

(72) Inventors: Jason P. Blackhurst, Charlotte, NC (US); Frederick A. Shahda, Charlotte, NC (US); Robert L. Abbott, Charlotte, NC (US); Alfred Hamilton, Charlotte, NC (US)

(21) Appl. No.: 14/542,020

(22) Filed: Nov. 14, 2014

(51) Int. Cl. G06Q 30/02

(52) U.S. Cl. CPC G06Q 30/0244

(57) ABSTRACT

Embodiments of the invention are directed to a system, method, or computer program product for providing advertisements to recommenders for network diffusion to a cluster or group of individuals associated with the recommender. In this way, advertisement effectiveness may be identified by presented to a single customer or recommender, and that recommender diffusion the advertisement data across his/her cluster of friends. In this way, the invention provides a means of delivering advertisements to appropriate recommenders for diffusion throughout a group of individuals. A network and recommender may be identified based on diffusion using transaction history, coincident mapping, and/or social network information. In this way, it is appreciated that there may be a greater advertisement value to present the advertisement to the recommender then allowing the advertisement to diffuse through the cluster.

### BACKGROUND

Advancements in internet technology, social media, and the like allow for a multitude of options for advertisers to advertise products and services. Furthermore, advertisers can reach a broader customer base than ever before. With these additional advertisement outlets, merchants may be able to invest more and more assets into advertising. However, while these advancement allow for a broader customer base to potentially be reached, it becomes difficult to target and track the effectiveness of any one advertisement campaign.

### BRIEF SUMMARY

Embodiments of the present invention address the above needs and/or achieve other advantages by providing apparatuses (e.g., a system, computer program product and/or other devices) and methods to provide advertisements to recommenders for network diffusion to a cluster or group of individuals associated with the recommender. In this way, it is acknowledged that advertisement effectiveness may not be based on a customer visualizing the advertisement, but instead because of an advertisement being presented to a single customer or recommender, and that recommender diffusion the advertisement data across his/her cluster of friends. In this way, the cluster of individuals may be more receptive to the advertisement based on the recommender as opposed to the cluster receiving the advertisement directly. In this way, the invention provides a means of delivering advertisements to appropriate recommenders for diffusion throughout a group of individuals. In this way, it is appreciated that there may be a greater advertisement value to present the advertisement only to the recommender than presenting the advertisement to everyone in the cluster.

In some embodiments, the invention may identify a network of customers. The network may include more than one individual linked together based on similar transaction history, coincided mapping, or social networking. As such, a network of customers may be a group of individuals that are linked in some way, such that the network may all be interested in one or more of the same or similar products and services, and the advertisements associated with the products and services. In some embodiments, the network of customers may comprise one or more individuals that know each other. In other embodiments, the network of customers may not know each other. The network of customers may comprise more than one customer.

Along with identifying a network, the invention may identify a recommender and cluster surrounding the recommender as part of the network. The recommender being identified as the customer that may directly or indirectly influence the other individuals within the network with respect to purchasing products and/or services within a category. The cluster being identified as one or more customers that are directly or indirectly influenced by the recommender. In some embodiments, there may be one recommender in each network. In other embodiments, there may be more than one recommender in each network. In some embodiments, an individual may be a recommender for one category of products within a network, but be part of a cluster for another category of products within the network.

In some embodiments, once the network has been identified as well as the recommenders and clusters surrounding the recommender have been identified for the network, the invention may identify advertisements that have potentially greater value for indirect presentation. In this way, the system may identify one or more advertisements that may be more influential if they are provided indirectly to a customer. In some embodiments, this identification may be based on the advertisement contents, such as simplicity of advertisement, comedy associated with the advertisement, and/or relative ease of recommender communicating contents of the advertisement to his/her cluster.

In some embodiments, the invention may also determine the recommenders influence ability with respect to the cluster around him/her for one or more advertisements. In this way, the system may identify recommenders and categories of products that particular recommender may be more influential to the cluster. For example, an individual identified as a recommender within a cluster for a particular category may be extremely influential for products associated with that category. For example, a recommender may be identified as having knowledge and influence among a cluster for electronic products. In this way, the recommender may have knowledge of electronics and be in a position within a cluster to influence the purchase of electronic equipment among the other individuals within the cluster. However, the recommender may not be influential for products in another category within the cluster.

Based on the identified advertisements with potential greater value for indirect presentation and based on the identified recommenders, the invention continues by matching the advertisements with recommenders that are influential in one or more categories. The categories include categories of products or services, such as sporting goods, electronics, clothing, automotive, home, garden, and the like.

In some embodiments, the system may present the recommender with the matched advertisements. In other embodiments, the system may present an advertiser with targeted recommenders to present the advertiser's advertisements to.

After the advertisement has been presented to the recommender, the invention continues by monitoring transaction data associated with the recommender and the cluster associated with the recommender. The system may receive subsequent customer financial transactions for transactions associated with merchants, products, and/or services of the advertisements for either the recommender or the cluster associated with the recommender. The invention may match the products of the transaction to products presented to the recommender and create feedback in the form of marketing effectiveness data to one or more advertisers.

Embodiments of the invention relate to systems, methods, and computer program products advertisement diffusion presentment, the invention comprising: identifying a network of individuals, wherein the network of individuals have a common interest in a product category; identifying one or more individuals as recommenders within the network of individuals, wherein the recommender is identified as having influence over one or more clusters of individuals in the network for the product category; receiving advertisements for the product category; matching one or more of the received advertisements to a recommender based at least in part on the influence of the recommenders for the product category of the one or more of the received advertisements; presenting the advertisement to the recommender and not to the cluster; receiving transaction data associated with transactions completed by the recommender and the cluster; matching the merchant, product, and/or service of the one or more advertisements presented to the recommender to transactions completed by the cluster; and providing advertising effectiveness data for advertisement diffusion through the network, based on the match.

In some embodiments, identifying the network of individuals, including identifying the recommender and the cluster further comprise using transaction history, coincident mapping, or social network mapping to identify the network of individuals, wherein transaction history identifies similar transactions for a category of products, coincided mapping maps likely association of individuals based on a category of products, and social networking mapping identifies a network of individuals associated with each other.

In some embodiments, the invention further comprises determining the recommender's influence on the network based on a number of individuals identified in the cluster around the recommender and the recommender's experience with products of the category of products.

In some embodiments, receiving advertisements for the product category further comprises determining a potential value for indirect presentation effectiveness of the advertisements based at least in part on advertisement contents, wherein advertisement contents comprises a simplicity of advertisement, such that the recommender can communicate contents of the advertisement to the network.

In some embodiments, matching the merchant, product, and/or service of the one or more advertisements presented to the recommender to transactions completed by the cluster further comprises identifying perfect matches and imperfect matches, wherein perfect matches are a same merchant, product, and/or service associated with a transaction of the network and the advertisement viewed by the recommender and imperfect matches are a similar merchant, product, and/or service of a customer transaction and the at least one advertisement viewed by the recommender. In some embodiments matching the merchant, product, and/or service of the one or more advertisements presented to the recommender to transactions completed by the cluster identifies diffusion of the advertisement from the recommender to the cluster based on only the recommender viewing the advertisement.

In some embodiments, providing advertising effectiveness data for advertisement diffusion through the network further comprises providing a confidence associated with a success of the at least one advertisement diffusion through the network based on a likelihood that the at least one advertisement was viewed by the recommender, a perfect or imperfect match of products of the at least one advertisement viewed by the recommender and the transactions of the cluster, and a time frame between the at least one advertisement for the product viewed by the recommender and the transaction for the product by the cluster for the product of the advertisement viewed by the recommender.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made to the accompanying drawings, wherein:

FIG. 1 provides a high level process flow illustrating advertisement network diffusion, in accordance with one embodiment of the present invention;

FIG. 2 provides an advertisement network diffusion system environment, in accordance with one embodiment of the present invention;

FIG. 3 provides a process map illustrating a process of identifying a network and cluster associated with the network, in accordance with one embodiment of the present invention;

FIG. 4 provides a process map illustrating means of identifying a network and cluster associated with the network, in accordance with one embodiment of the present invention;

FIG. 5 provides a process map illustrating social network diffusion, in accordance with one embodiment of the present invention; and

FIG. 6 provides a process map illustrating creating and providing marketing effectiveness tracking data based on advertisement network diffusion, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to elements throughout. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of businesses that may provide payment accounts for transactions.

Some portions of this disclosure are written in terms of a financial institution's unique position with respect to customer transactions. As such, a financial institution may be able to utilize its unique position to monitor and identify transactions for products or with merchants that utilize financial institution accounts to complete the transactions.

The embodiments described herein may refer to the initiation and completion of a transaction. Unless specifically limited by the context, a “transaction”, “transaction event” or “point of transaction event” refers to any customer completing or initiating a purchase for a product, service, or the like. The embodiments described herein may refer to an “advertisement.” An advertisement, as used herein may include one or more of a deal, offer, coupon, promotion, incentive, commercial, advertisement, or the like. The advertisement may be for a product, service, merchant, merchant, brand, or the like. Furthermore, the term “product” as used herein may refer to any product, service, good, or the like that may be purchased through a transaction.

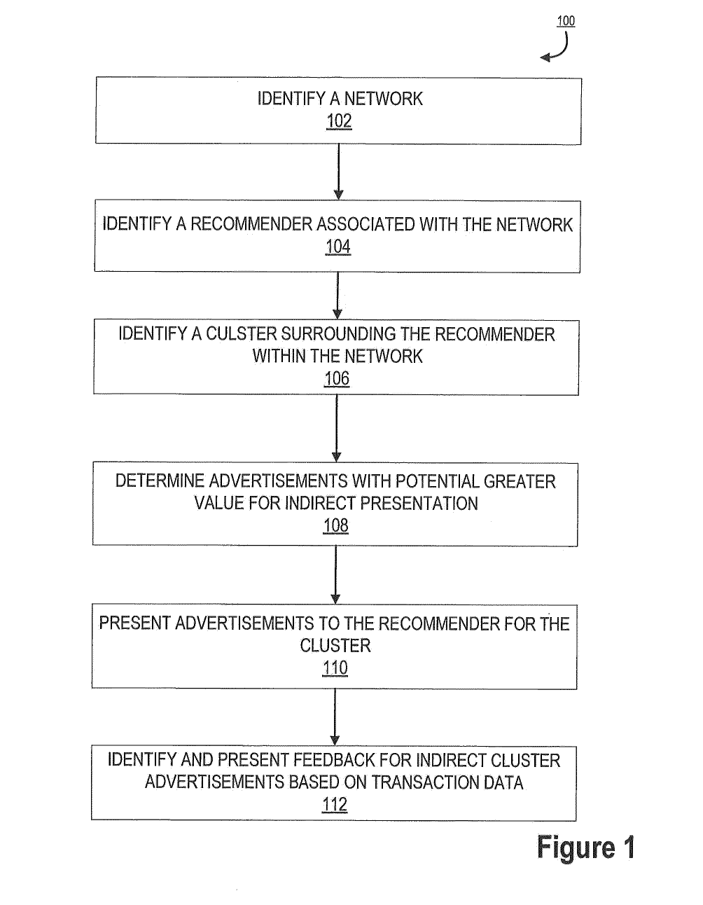

FIG. 1 provides a high level process flow illustrating advertisement network diffusion 100, in accordance with one embodiment of the present invention. The process 100 is initiated by identifying a network 102. The network may include more than one individual linked together based on similar transaction history, coincided mapping, and/or social networking. As such, a network of customers may be a group of individuals that are linked in some way, such that the network may all be interested in one or more of the same or similar products and services. In some embodiments, the network of customers may comprise one or more individuals that know each other. In other embodiments, the network of customers may not know each other. The network of customers may comprise more than one customer.

Next, as illustrated in block 104, the process 100 continues by identifying a recommender associated with the network. The recommender being identified as the customer that may directly or indirectly influence the other individuals within the network with respect to purchasing products and/or services within a category. In some embodiments, there may be one recommender in each network. In other embodiments, there may be more than one recommender in each network. In some embodiments, an individual may be a recommender for one category of products within a network, but be part of a cluster for another category of products within the network.

As illustrated in block 106, the process 100 next identifies a cluster surrounding the recommender within the network. The cluster is a group of individuals that are identified as being directly or indirectly influenced by the recommender. An individual may be a part of one or more clusters. The clusters may be identified from social networks, transactions, or coincident mapping or the like.

As illustrated in block 108, the process 100 continues, once the network has been identified as well as the recommenders and clusters surrounding the recommender have been identified for the network, to identify advertisements that have potentially greater value for indirect presentation. In this way, the system may identify one or more advertisements that may be more influential if they are provided indirectly to a customer. In some embodiments, this identification may be based on the advertisement contents, such as simplicity of advertisement, comedy associated with the advertisement, and/or relative ease of recommender communicating contents of the advertisement to his/her cluster. In some embodiments, the invention may also determine the recommenders influence ability with respect to the cluster around him/her for one or more advertisements. In this way, the system may identify recommenders and categories of products that particular recommender may be more influential to the cluster.

Next, as illustrated in block 110, the process 100 continues by presenting advertisements to the recommender. These advertisements will be presented to the recommender in hopes that the recommender will disseminate the information associated with the advertisements to a cluster surrounding the recommender. In some embodiments, the system may present the recommender with the advertisements. In other embodiments, the system may present an advertiser with targeted recommenders to present the advertiser's advertisements to. In some embodiments, the channel of presentation of the advertiser may relate to the recommender's cluster. For example, a recommender may be followed by a cluster on a social network. In this way, the advertisement may be presented to the recommender on the social network as opposed to via the television or the like. In this way, the system can amplify the advertisement and make it more powerful based on the channel associated therewith. Furthermore, the presentation to the recommender can be time and/or location based. In this way, the system may identify a time or location for presentation of the advertisement to provide greater value for the advertisement to the recommender to diffuse through to the cluster.

Finally, as illustrated in block 112, the process 100 concludes by identifying and presenting feedback for the indirect cluster advertisement based on transaction data for the cluster and recommender. As such, after the advertisement has been presented to the recommender, the invention may monitor transaction data associated with the recommender and the cluster associated with the recommender. The system may receive subsequent customer financial transactions for transactions associated with merchants, products, and/or services of the advertisements for either the recommender or the cluster associated with the recommender. The invention may match the products of the transaction to products presented to the recommender and create feedback in the form of marketing effectiveness data to one or more advertisers.

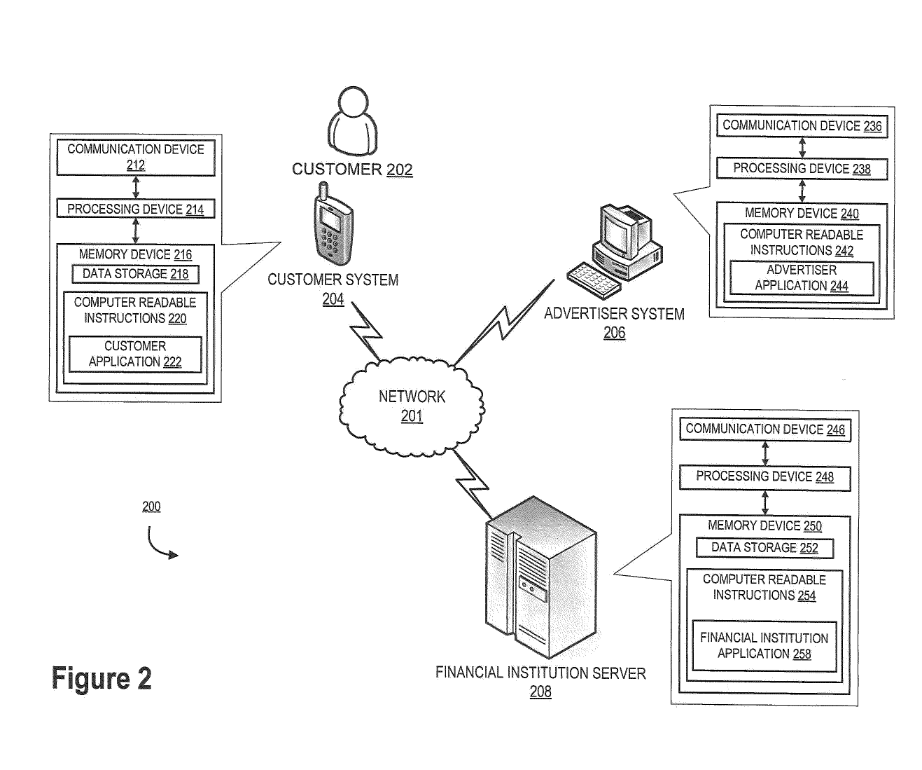

FIG. 2 provides an advertisement network diffusion system environment 200, in accordance with one embodiment of the present invention. As illustrated in FIG. 2, the financial institution server 208 is operatively coupled, via a network 201 to the customer system 204, and to the advertiser system 206. In this way, the financial institution server 208 can send information to and receive information from the customer system 204 and the advertiser system 206 to provide network diffusion for advertisement presentment and impressions. FIG. 2 illustrates only one example of an embodiment of an advertisement network diffusion system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network 201.

In some embodiments, the customer 202 is an individual associated with a network. In some embodiments, the individual may be someone with influence over the other individuals associated with the network for a product purchase. In some embodiments, the individual may be influenced by one or more individuals in the network with respect to a product purchase. The customer 202 may view an advertisement either directly or indirectly. Subsequently, in some embodiments, the customer 202 may purchase a product using a customer system 204. In some embodiments, the customer 202 may be a merchant or a person, employee, agent, associate, independent contractor, and the like that has an account or business with a financial institution or another financial institution that may provide payment to complete a transaction.

FIG. 2 also illustrates a customer system 204. The customer system 204 generally comprises a communication device 212, a processing device 214, and a memory device 216. The customer system 204 is a computing system that allows a customer 202 to interact with the financial institution and other systems on the advertisement network diffusion system environment 200. In this way, a customer 202 may, via the customer system 204, interact with a network or cluster via social media, and/or set up payment or transaction accounts to complete transactions for products and/or services of advertisements. The processing device 214 is operatively coupled to the communication device 212 and the memory device 216. The processing device 214 uses the communication device 212 to communicate with the network 201 and other devices on the network 201, such as, but not limited to the advertiser system 206 and the financial institution server 208. As such, the communication device 212 generally comprises a modem, server, or other device for communicating with other devices on the network 201.

The customer system 204 comprises computer-readable instructions 220 and data storage 218 stored in the memory device 216, which in one embodiment includes the computer-readable instructions 220 of a customer application 222. In this way, a customer 202 may interact with a cluster or network of individuals via the network 201, open a financial institution account, remotely communicate with the financial institution, authorize and complete a transaction, or complete a transaction using the customer's customer system 204. The customer system 204 may be, for example, a desktop personal computer, a mobile system, such as a cellular phone, smart phone, personal data assistant (PDA), laptop, or the like. Although only a single customer system 204 is depicted in FIG. 2, the system environment 200 may contain numerous customer systems 204.

As further illustrated in FIG. 2, the financial institution server 208 generally comprises a communication device 246, a processing device 248, and a memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device.

The processing device 248 is operatively coupled to the communication device 246 and the memory device 250. The processing device 248 uses the communication device 246 to communicate with the network 201 and other devices on the network 201, such as, but not limited to the advertiser system 206 and the customer system 204. As such, the communication device 246 generally comprises a modem, server, or other device for communicating with other devices on the network 201.

As further illustrated in FIG. 2, the financial institution server 208 comprises computer-readable instructions 254 stored in the memory device 250, which in one embodiment includes the computer-readable instructions 254 of a financial institution application 258. In some embodiments, the memory device 250 includes data storage 252 for storing data related to network diffusion advertisement presentment, but not limited to data created and/or used by the financial institution application 258.

In the embodiment illustrated in FIG. 2 and described throughout much of this specification, the financial institution application 258 may identify a network including a recommender and cluster, identify recommenders influence ability, receive advertisements with potential value for indirect presentation, match advertisements to recommenders, present matched advertisements, and track financial data of recommenders and clusters to provide feedback for the indirect cluster advertisement.

In some embodiments, the financial institution application 258 may identify a network including a recommender and cluster. In this way, the network, cluster, and recommenders may be identified based on transaction history matching, coincident mapping, social network linkage, or the like by the financial institution application 258. The financial institution application 258 will identify recommenders that may diffuse ideas, concepts, and product advertisements throughout a cluster based on his/her position as recommender within the network for that one or more product categories. The recommender being identified as the customer 202 that may directly or indirectly influence the other individuals within the network with respect to purchasing products and/or services within a category. The financial institution application 258 may also identify clusters of customers 202 around the recommender. The customers 202 in the cluster may be one or more individuals identified to receive and accept recommendations from a recommender for a particular product or category of products. In this way, the cluster consists of one or more customers 202 that are directly or indirectly influenced by the recommender.

In some embodiments, the financial institution application 258 may identify recommenders influence ability. While a measurement of a recommenders influence may be difficult to precisely quantify, the financial institution application 258 may base influence on a category of products and/or the size of the identified cluster surrounding the recommender.

In some embodiments, the recommender's influence may be based on category of product. In this way, the financial institution application 258 may identify recommenders and categories of products that particular recommender may be more influential to the cluster. For example, an individual identified as a recommender within a cluster for a particular category may be extremely influential for products associated with that category. For example, a recommender may be identified as having knowledge and influence among a cluster for electronic products. In this way, the recommender may have knowledge of electronics and be in a position within a cluster to influence the purchase of electronic equipment among the other individuals within the cluster. However, the recommender may not be influential for products in another category within the cluster.

In some embodiments, the influence ability of the recommender may be on the recommender's status and/or the number of individuals in a cluster. In some embodiments, a recommender's influence status may make him/her more likely to influence the members of the cluster for advertisement diffusion purposes. The influence status may increase if the recommender is a celebrity or it is determined that the recommender has significant influence over cluster members. In some embodiments, the number of individuals in the recommender's cluster may affect the recommenders influence ability with respect to the cluster. The more individuals identified within the cluster, the more possibility for influence by the recommender in these circumstances.

In some embodiments, the financial institution application 258 may receive advertisements with potential value for indirect presentation. In this way, the financial institution application 258 may receive, from the advertisement system 206, one or more advertisements with potential value for indirect presentation. In some embodiments, the financial institution application 258 may determine the advertisements with potential value for indirect presentation. The advertisements with potential value for indirect presentation may be determined based on market research, product data, advertiser data, or the like. In this way, the advertisement system 206 may identify one or more advertisements that may be more influential if they are provided indirectly to a customer 202. In some embodiments, this identification may be based on the advertisement contents, such as simplicity of advertisement, comedy associated with the advertisement, and/or relative ease of recommender communicating contents of the advertisement to his/her cluster.

In some embodiments, the financial institution application 258 may match advertisements to recommenders. In this way, the financial institution application 258 may match the advertisements determined to have a potential value for indirect presentment with the appropriate recommenders. The match is based on the identified advertisements with potential value for indirect presentation, the identified recommender, and the category of product identified for that recommender and cluster. The categories include categories of products or services, such as sporting goods, electronics, clothing, automotive, home, garden, and the like.

In some embodiments, the financial institution application 258 may present matched advertisements. In some embodiments, the financial institution application 258 may present the matched advertisements directly to the recommender for the cluster. In some embodiments, the financial institution application 258 may present an advertiser with targeted recommenders to present the advertiser's advertisements to. As such, the advertisement may be specifically targeted to the recommender and not the cluster or other individuals. In this way, the advertisement may be presented a limited time and not have a large advertisement cost associated therewith. The advertisement may be presented to the recommender via online means, such as through e-mail, a webpage, or the like or the advertisement may be presented to the recommender via off line means, such as via the newspaper, television, flyer, or the like. Based on the determination of recommender network diffusion, the advertiser is presenting the advertisement to the recommender to disseminate the advertisement among his/her cluster. This may have greater impact than the individuals of the cluster receiving the advertisements. Providing a unique means of advertisement based on diffusion of advertisement impressions through a network.

In some embodiments, the financial institution application 258 may track financial data of recommenders and clusters to provide feedback for the indirect cluster advertisement. In this way, the financial institution application 258 may monitor transaction data for the cluster and the recommender after the advertisement has been presented to the recommender. In this way, after the advertisement has been presented to the recommender, the financial institution application 258 continues by monitoring transaction data associated with the recommender and the cluster associated with the recommender. The financial institution application 258 may receive subsequent customer 202 financial transactions for transactions associated with merchants, products, and/or services of the advertisements for either the recommender or the cluster associated with the recommender. The financial institution application 258 may match the products of the transaction to products presented to the recommender and create feedback in the form of marketing effectiveness data to one or more advertisers. In this way, the financial institution application 258 may compile advertisement effectiveness data and provide it to the advertisers via the advertiser system 206 for marketing analysis and effectiveness tracking.

As illustrated in FIG. 2, the advertiser system 206 is connected to the financial institution server 208 and is associated with the entity providing the advertisements. In this way, while only one advertiser system 206 is illustrated in FIG. 2, it is understood that multiple advertiser systems may make up the system environment 200. The advertiser system 206 generally comprises a communication device 236, a processing device 238, and a memory device 240. The advertiser system 206 comprises computer-readable instructions 242 stored in the memory device 240, which in one embodiment includes the computer-readable instructions 242 of an advertiser application 244.

In the embodiment illustrated in FIG. 2, the advertiser application 244 identifies advertisements for indirect presentment, provides advertisements to customers 202, and receives marketing effectiveness data.

In some embodiments, the advertiser application 244 may identify advertisements for indirect presentment. In this way, the advertiser application 244 may determine which advertisements have potential value for indirect presentation. The advertisements with potential value for indirect presentation may be determined based on market research, product data, advertiser data, or the like. In this way, the advertiser application 244 may identify one or more advertisements that may be more influential if they are provided indirectly to a customer. In some embodiments, this identification may be based on the advertisement contents, such as simplicity of advertisement, comedy associated with the advertisement, and/or relative ease of recommender communicating contents of the advertisement to his/her cluster.

In some embodiments, the advertiser application 244 may provide the advertisements to the customers 202. The advertiser application 244 may present advertisements via online means or offline means based on the targeted audience the advertiser wishes to target.

In some embodiments, the advertiser application 244 may receive marketing effectiveness data from the financial institution server 208 based on the results of the diffusion advertisement presentation.

It is understood that the servers, systems, and devices described herein illustrate one embodiment of the invention. It is further understood that one or more of the servers, systems, and devices can be combined in other embodiments and still function in the same or similar way as the embodiments described herein.

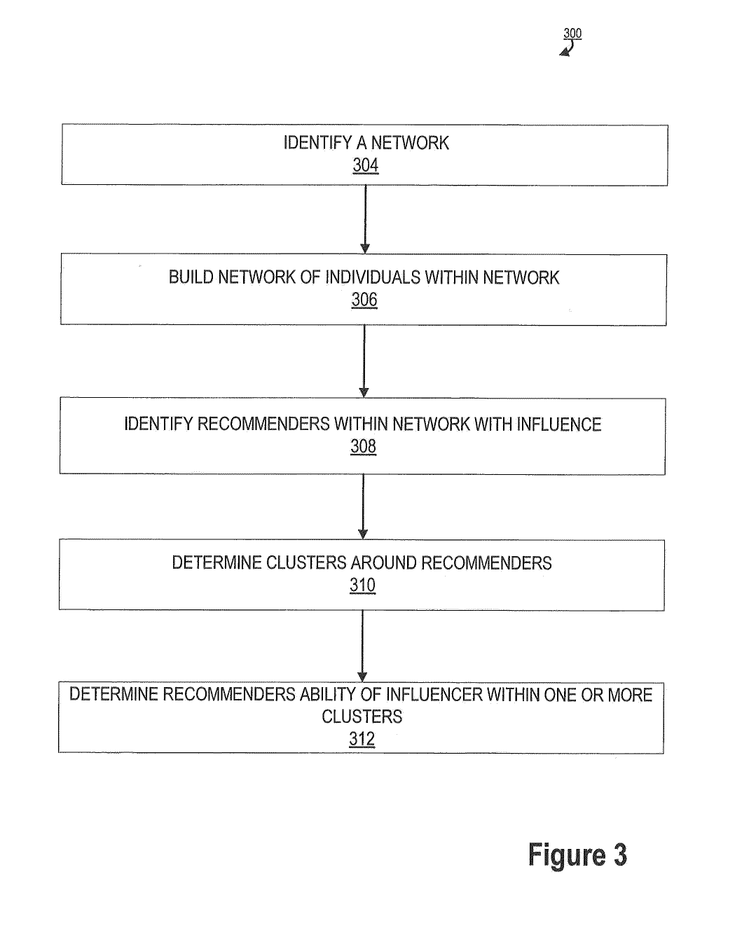

FIG. 3 illustrates a process map for a process of identifying a network and cluster associated with the network 300, in accordance with one embodiment of the present invention. In this way, the process 300 identifies a network of individuals that include a recommender and cluster around the recommender. The network identified includes individuals that may be influenced indirectly by advertisements. In this way, it is acknowledged that advertisement effectiveness may not be based on a customer visualizing the advertisement, but instead because of an advertisement being presented to a single customer or recommender, and that recommender diffusion the advertisement data across his/her cluster of friends within the network. In this way, the cluster of individuals may be more receptive to the advertisement based on the recommender as opposed to the cluster receiving the advertisement directly. In this way, the invention provides a means of delivering advertisements to appropriate recommenders for diffusion throughout a group of individuals. In this way, it is appreciated that there may be a greater advertisement value to present the advertisement only to the recommender than presenting the advertisement to everyone in the cluster.

The process 300 identifies the network, recommender, and cluster around the recommender for providing advertisements for network diffusion advertisement. The process 300 is initiated by first identifying a network, as illustrated in block 304. A network may include a social network, financial transaction network, financial transaction diffusion, coincident mapping or the like. The network may include individuals with common interests with respect to product categories. As such, the individuals within the network may all have an interest in a category of products, such as clothing, electronics, sporting goods, or the like.

As illustrated in block 306, the system may build a network of individuals within the network based on the product categories. As such, the system may identify groups of individuals that are linked together based on transaction history, coincident mapping, social networking, or the like. The network is grouped based on common interests in one or more product categories. Next, as illustrated in block 308, the process 300 continues to identify recommenders within the network that have influencer within the network. The recommender being identified as a customer that may directly or indirectly influence the other individuals within the network with respect to purchasing products and/or services within a category. Next, as illustrated in block 310 the process 300 continues by determining a cluster around the recommenders. The cluster being identified as one or more customers that are directly or indirectly influenced by the recommender.

Finally, as illustrated in block 312, the process 300 ends by determining a recommender's ability of influence within one or more clusters. In this way, the system identifies categories of products that a recommender has an ability to influence the cluster.

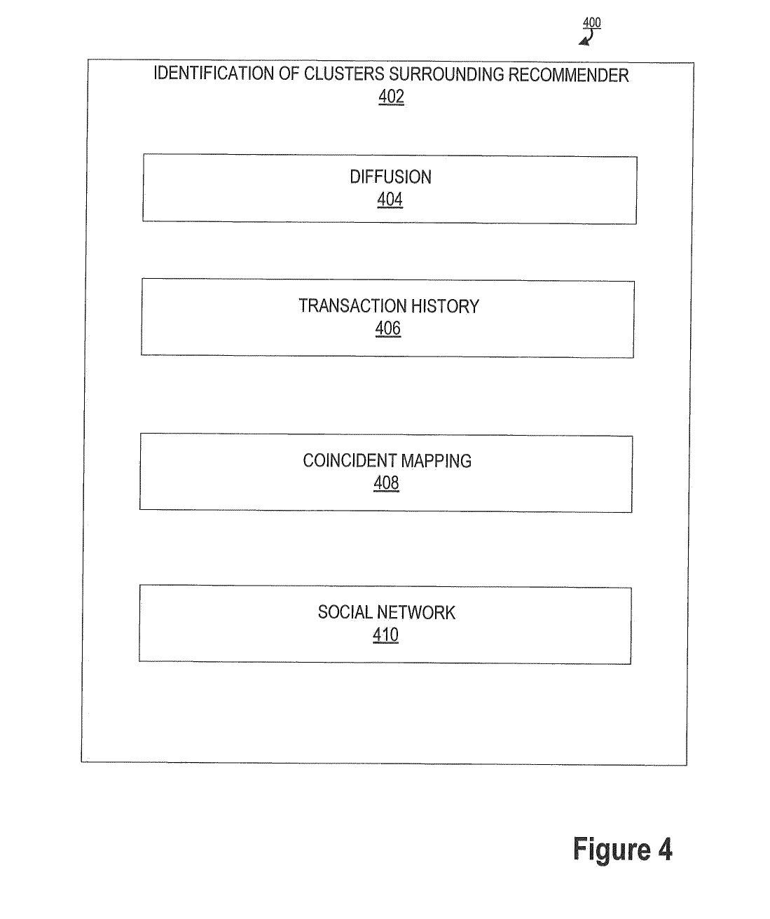

FIG. 4 illustrates a process map for a means of identifying a network and cluster associated with the network 400, in accordance with one embodiment of the present invention. In some embodiments, the process 400 provides a means for identifying a network. In other embodiments, the process 400 provides a means for identifying a cluster within the network. In yet other embodiments, the process 400 provides a means for identifying a recommender within the network.

As illustrated in section 404, one of the means of identifying a network, cluster, and/or recommender within the cluster includes diffusion. Diffusion is a way of determining and identifying a rate of potential spreading of the advertisement information through a cluster. Diffusion may utilize transaction history 406, coincident mapping 408, and/or social networking 410 to identify a network, cluster, and/or recommender to present advertisements to the recommender for diffusion through the cluster for indirect advertisement presentment.

As illustrated in block 406, one of the means of identifying a network, cluster, and/or recommender within the cluster includes transaction history review and identification. Because of the unique position of the financial institution providing the network diffusion system, the system may be able to identify and correlate various transactions of individuals. In this way, the system may correlate individuals with similar transaction histories into a same network, or cluster. In this way, the system may identify similar transaction histories based on a similar merchant, product, geographic location, time, or the like associated with transactions. The system may generalize the transaction data and utilize it to develop a network, cluster, or recommender associated with an advertisement impression for network diffusion.

As illustrated in block 408, coincident mapping may be one of the means of identifying a network, cluster, and/or recommender within the cluster. Coincident mapping includes making locations using transaction history or the like of customers to identify a relationship between the customers. In this way, mapping may be able to identify a cluster of individuals or simply a random pattern of transactions and distinguish the same using coincident mapping algorithms. In this way, random transactions may be correlated to determine if the transactions are coincidental or may be part of a network or cluster.

Next, as illustrated in block 410, social network mapping may be one of the means of identifying a network, cluster, and/or recommender within the cluster. In this way, the system may identify one or more individuals and the social network of friends, likes, followers, or the like associated with that individual. The social network associated with the individual may be interlinked with social networks of other individuals in order to create a cluster of individuals.

The network and clusters associated therewith are identified via transaction history 406 identification and matching, coincident mapping 408, and/or social network 410 matching. In this way, the system may identify one or more products that the customers in a network or cluster may all be interested in. Furthermore, the system may identify a recommender, which based on the transaction history 406 identification and matching, coincident mapping 408, and/or social network 410 matching for that customer, may be shown as being influential for that particular product category to the other members of the cluster.

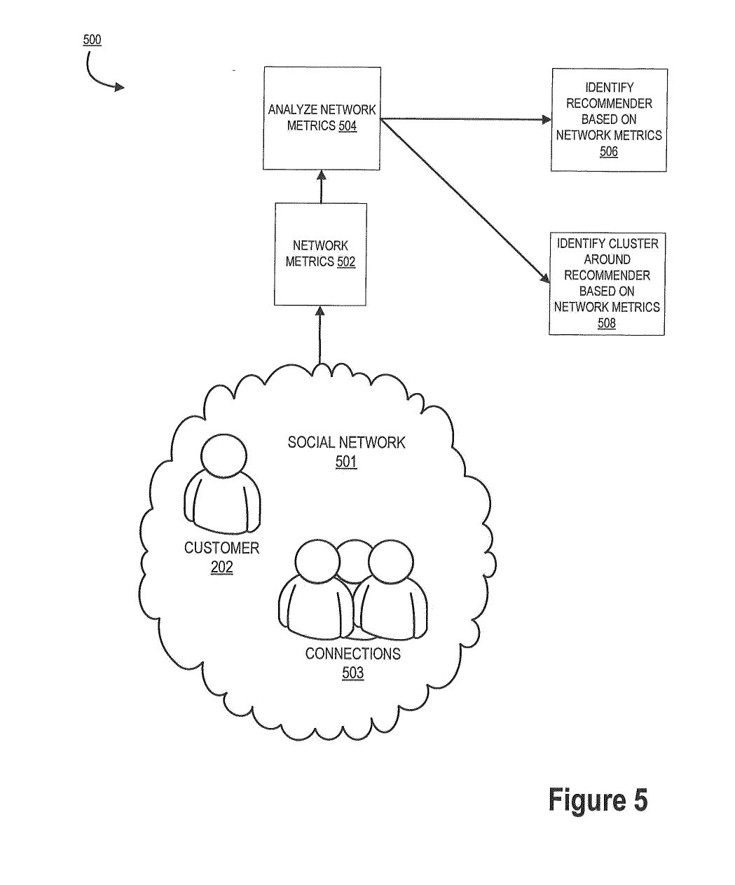

FIG. 5 provides a process map illustrating social network diffusion 500, in accordance with one embodiment of the present invention. The social network 501, includes the customer 202 and the customer connections 503 may be accessed by the system. In some embodiments, the customer 202 may be an identified recommender. In yet other embodiments, the customer 202 may be a cluster member associated with an individual requestor. The customer connections 503 may be identified by the system as being a cluster around the customer 202 that has been identified as a recommender.

The system may retrieve network metrics from the social network, in block 502. The network metrics may include network position within the network, posts, product information, connections, deepening value, and/or other data identifying a recommender or cluster individual and the products that the customer 202 may be interested in. As represented in block 504 the network metrics are analyzed by the system using a network science algorithm to determine the location of the customer 202 within the social network 501 based on product category. In this way, the system may identify a customer 202 as a recommender for one category of products and a cluster member for another category of product. The customer's posts, followers, links, or the like may all lead to a determination of the category of product for the network diffusion for advertisements.

In some embodiments, once the system has retrieved and analyzed the network metrics the network metrics are used to identify a recommender based on the network metrics, as illustrated in block 506. In some embodiments, once the system has retrieved and analyzed the network metrics the network metrics are used to identify a cluster around a recommender based on the network metrics, as illustrated in block 508.

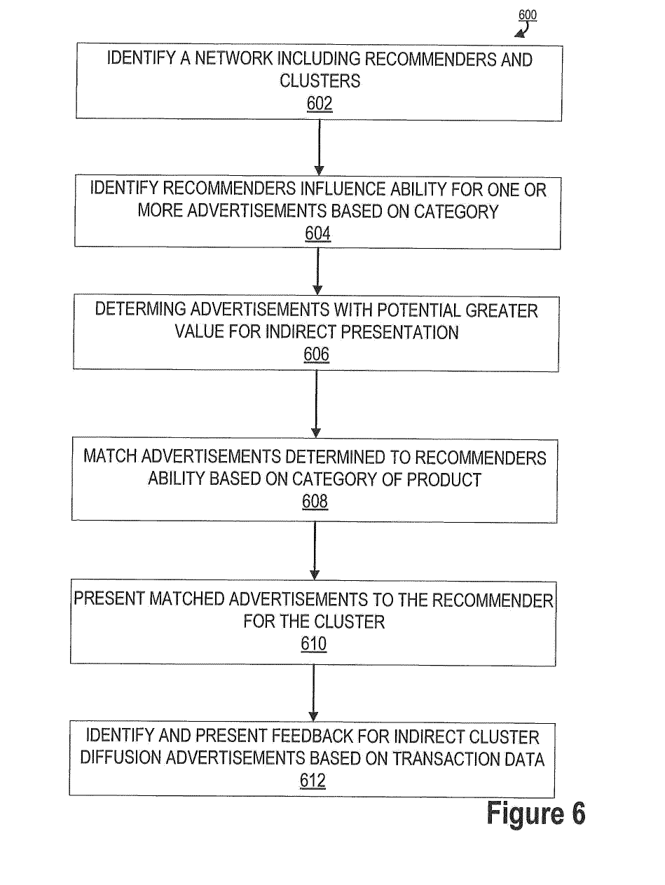

FIG. 6 illustrates a process map for creating and providing marketing effectiveness tracking data based on advertisement network diffusion 600, in accordance with one embodiment of the present invention. As illustrated in block 602, the process is initiated when a network, including recommenders and a cluster of individuals around the recommender are identified. In this way, the network, cluster, and recommenders may be identified based on transaction history matching, coincident mapping, social network linkage, or the like. As such, a network of customers may be a group of individuals that are linked in some way, such that the network may all be interested in one or more of the same or similar products and services, and the advertisements associated with the products and services. In some embodiments, the network of customers may comprise one or more individuals that know each other. In other embodiments, the network of customers may not know each other. The network of customers may comprise more than one customer.

The system will identify recommenders that may diffuse ideas, concepts, and product advertisements throughout a cluster based on his/her position as recommender within the network for that one or more product categories. The recommender being identified as the customer that may directly or indirectly influence the other individuals within the network with respect to purchasing products and/or services within a category.

The system may also identify clusters around the recommender. The individuals in the cluster may be one or more individuals identified to receive and accept recommendations from a recommender for a particular product or category of products. In this way, the cluster consists of one or more customers that are directly or indirectly influenced by the recommender.

Next, as illustrated in block 604 of FIG. 6, the process 600 continues by identifying the recommenders influence ability for one or more advertisements. In this way, it is identified that the recommender may only be a recommender for one or more categories of products. In this way, the category of products that the recommender is a recommender for is identified. Also identified is how influential the recommender is and how many individuals are in the recommender's cluster. Furthermore, the influence of a recommender may be based on previous purchases of the recommender. The influence ability of the recommender is based on the recommender's status and/or the number of individuals in a cluster. In some embodiments, a recommender's influence status may make him/her more likely to influence the members of the cluster for advertisement diffusion purposes. The influence status may increase if the recommender is a celebrity or it is determined that the recommender has significant influence over cluster members. In some embodiments, the number of individuals in the recommender's cluster may affect the recommenders influence ability with respect to the cluster. The more individuals identified within the cluster, the more possibility for influence by the recommender in these circumstances.

Furthermore, the recommender's influence may be based on category of product. In this way, the system may identify recommenders and categories of products that particular recommender may be more influential to the cluster. For example, an individual identified as a recommender within a cluster for a particular category may be extremely influential for products associated with that category. For example, a recommender may be identified as having knowledge and influence among a cluster for electronic products. In this way, the recommender may have knowledge of electronics and be in a position within a cluster to influence the purchase of electronic equipment among the other individuals within the cluster. However, the recommender may not be influential for products in another category within the cluster.

Next, as illustrated in block 606 a determination is made as to which advertisements have potential value for indirect presentation. The advertisements with potential value for indirect presentation may be determined based on market research, product data, advertiser data, or the like. In this way, the system may identify one or more advertisements that may be more influential if they are provided indirectly to a customer. In some embodiments, this identification may be based on the advertisement contents, such as simplicity of advertisement, comedy associated with the advertisement, and/or relative ease of recommender communicating contents of the advertisement to his/her cluster.

As illustrated in block 608, the process 600 continues by matching the advertisements determined to have a potential value for indirect presentment with the appropriate recommenders. The match is based on the identified advertisements with potential value for indirect presentation, the identified recommender, and the category of product identified for that recommender and cluster. The categories include categories of products or services, such as sporting goods, electronics, clothing, automotive, home, garden, and the like.

As illustrated in block 610, the matched advertisements are presented to the recommender for the cluster. In some embodiments, the system may present the recommender with the matched advertisements. In other embodiments, the system may present an advertiser with targeted recommenders to present the advertiser's advertisements to. As such, the advertisement may be specifically targeted to the recommender and not the cluster or other individuals. In this way, the advertisement may be presented a limited time and not have a large advertisement cost associated therewith. The advertisement may be presented to the recommender via online means, such as through e-mail, a webpage, or the like or the advertisement may be presented to the recommender via off line means, such as via the newspaper, television, flyer, or the like. Based on the determination of recommender network diffusion, the advertiser is presenting the advertisement to the recommender to disseminate the advertisement among his/her cluster. This may have greater impact than the individuals of the cluster receiving the advertisements. Providing a unique means of advertisement based on diffusion of advertisement impressions through a network.

In some embodiments, the channel of presentation of the advertiser may relate to the recommender's cluster. For example, a recommender may be followed by a cluster on a social network. In this way, the advertisement may be presented to the recommender on the social network as opposed to via the television or the like. In this way, the system can amplify the advertisement and make it more powerful based on the channel associated therewith. Furthermore, the presentation to the recommender can be time and/or location based. In this way, the system may identify a time or location for presentation of the advertisement to provide greater value for the advertisement to the recommender to diffuse through to the cluster.

Finally, as illustrated in block 612, the process 600 ends by identifying and presenting feedback for the indirect cluster diffusion advertisements. The feedback is provided based on a monitoring of transaction data for the cluster and the recommender after the advertisement has been presented to the recommender. In this way, after the advertisement has been presented to the recommender, the invention continues by monitoring transaction data associated with the recommender and the cluster associated with the recommender. The system may receive subsequent customer financial transactions for transactions associated with merchants, products, and/or services of the advertisements for either the recommender or the cluster associated with the recommender. The invention may match the products of the transaction to products presented to the recommender and create feedback in the form of marketing effectiveness data to one or more advertisers.

As will be appreciated by one of ordinary skill in the art, the present invention may be embodied as an apparatus (including, for example, a system, a machine, a device, a computer program product, and/or the like), as a method (including, for example, a business process, a computer-implemented process, and/or the like), or as any combination of the foregoing. Accordingly, embodiments of the present invention may take the form of an entirely software embodiment (including firmware, resident software, micro-code, and the like), an entirely hardware embodiment, or an embodiment combining software and hardware aspects that may generally be referred to herein as a “system.” Furthermore, embodiments of the present invention may take the form of a computer program product that includes a computer-readable storage medium having computer-executable program code portions stored therein. As used herein, a processor may be “configured to” perform a certain function in a variety of ways, including, for example, by having one or more general-purpose circuits perform the functions by executing one or more computer-executable program code portions embodied in a computer-readable medium, and/or having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, infrared, electromagnetic, and/or semiconductor system, apparatus, and/or device. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as a propagation signal including computer-executable program code portions embodied therein.

It will also be understood that one or more computer-executable program code portions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

It will further be understood that some embodiments of the present invention are described herein with reference to flowchart illustrations and/or block diagrams of systems, methods, and/or computer program products. It will be understood that each block included in the flowchart illustrations and/or block diagrams, and combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

It will also be understood that the one or more computer-executable program code portions may be stored in a transitory or non-transitory computer-readable medium (e.g., a memory, and the like) that can direct a computer and/or other programmable data processing apparatus to function in a particular manner, such that the computer-executable program code portions stored in the computer-readable medium produce an article of manufacture, including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with operator and/or human-implemented steps in order to carry out an embodiment of the present invention.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for advertisement diffusion presentment, the system comprising:
a memory device with non-transitory computer-readable program code stored thereon;
a communication device;
a processing device operatively coupled to the memory device and the communication device, wherein the processing device is configured to execute the computer-readable program code to:
identify a network of individuals, wherein the network of individuals have a common interest in a product category;
identify one or more individuals as recommenders within the network of individuals, wherein the recommender is identified as having influence over one or more clusters of individuals in the network for the product category;
receive advertisements for the product category;
match one or more of the received advertisements to a recommender based at least in part on the influence of the recommenders for the product category of the one or more of the received advertisements;
present the advertisement to the recommender and not to the cluster;
receive transaction data associated with transactions completed by the recommender and the cluster;
match the merchant, product, and/or service of the one or more advertisements presented to the recommender to transactions completed by the cluster; and
provide advertising effectiveness data for advertisement diffusion through the network, based on the match.

2. The system of claim 1, wherein the operation to identify the network of individuals, including identifying the recommender and the cluster further comprise using transaction history, coincident mapping, or social network mapping to identify the network of individuals, wherein transaction history identifies similar transactions for a category of products, coincided mapping maps likely association of individuals based on a category of products, and social networking mapping identifies a network of individuals associated with each other.

3. The system of claim 1 further comprises determining the recommender's influence on the network based on a number of individuals identified in the cluster around the recommender and the recommender's experience with products of the category of products.

4. The system of claim 1, wherein the operation to receive advertisements for the product category further comprises determining a potential value for indirect presentation effectiveness of the advertisements based at least in part on advertisement contents, wherein advertisement contents comprises a simplicity of advertisement, such that the recommender can communicate contents of the advertisement to the network.

5. The system of claim 1, wherein the operation to match the merchant, product, and/or service of the one or more advertisements presented to the recommender to transactions completed by the cluster further comprises identifying perfect matches and imperfect matches, wherein perfect matches are a same merchant, product, and/or service associated with a transaction of the network and the advertisement viewed by the recommender and imperfect matches are a similar merchant, product, and/or service of a customer transaction and the at least one advertisement viewed by the recommender.

6. The system of claim 1, wherein the operation to match the merchant, product, and/or service of the one or more advertisements presented to the recommender to transactions completed by the cluster further identifies diffusion of the advertisement from the recommender to the cluster based on only the recommender viewing the advertisement.

7. The system of claim 1, wherein the operation to provide advertising effectiveness data for advertisement diffusion through the network further comprises providing a confidence associated with a success of the at least one advertisement diffusion through the network based on a likelihood that the at least one advertisement was viewed by the recommender, a perfect or imperfect match of products of the at least one advertisement viewed by the recommender and the transactions of the cluster, and a time frame between the at least one advertisement for the product viewed by the recommender and the transaction for the product by the cluster for the product of the advertisement viewed by the recommender.

8. A computer program product for advertisement diffusion, the computer program product comprising at least one non-transitory computer-readable medium having computer-readable program code portions embodied therein, the computer-readable program code portions comprising:
an executable portion configured for identifying a network of individuals, wherein the network of individuals have a common interest in a product category;
an executable portion configured for identifying one or more individuals as recommenders within the network of individuals, wherein the recommender is identified as having influence over one or more clusters of individuals in the network for the product category;
an executable portion configured for receiving advertisements for the product category;
an executable portion configured for matching one or more of the received advertisements to a recommender based at least in part on the influence of the recommenders for the product category of the one or more of the received advertisements;
an executable portion configured for presenting the advertisement to the recommender and not to the cluster;
an executable portion configured for receiving transaction data associated with transactions completed by the recommender and the cluster;
an executable portion configured for matching the merchant, product, and/or service of the one or more advertisements presented to the recommender to transactions completed by the cluster; and
an executable portion configured for providing advertising effectiveness data for advertisement diffusion through the network, based on the match.

9. The computer program product of claim 8, wherein identifying the network of individuals, including identifying the recommender and the cluster further comprise using transaction history, coincident mapping, or social network mapping to identify the network of individuals, wherein transaction history identifies similar transactions for a category of products, coincided mapping maps likely association of individuals based on a category of products, and social networking mapping identifies a network of individuals associated with each other.

10. The computer program product of claim 8, further comprising an executable portion configured for determining the recommender's influence on the network based on a number of individuals identified in the cluster around the recommender and the recommender's experience with products of the category of products.

11. The computer program product of claim 8, wherein receiving advertisements for the product category further comprises determining a potential value for indirect presentation effectiveness of the advertisements based at least in part on advertisement contents, wherein advertisement contents comprises a simplicity of advertisement, such that the recommender can communicate contents of the advertisement to the network.

12. The computer program product of claim 8, wherein matching the merchant, product, and/or service of the one or more advertisements presented to the recommender to transactions completed by the cluster further comprises identifying perfect matches and imperfect matches, wherein perfect matches are a same merchant, product, and/or service associated with a transaction of the network and the advertisement viewed by the recommender and imperfect matches are a similar merchant, product, and/or service of a customer transaction and the at least one advertisement viewed by the recommender.

13. The computer program product of claim 8, wherein matching the merchant, product, and/or service of the one or more advertisements presented to the recommender to transactions completed by the cluster further identifies diffusion of the advertisement from the recommender to the cluster based on only the recommender viewing the advertisement.

14. The computer program product of claim 8, wherein providing advertising effectiveness data for advertisement diffusion through the network further comprises providing a confidence associated with a success of the at least one advertisement diffusion through the network based on a likelihood that the at least one advertisement was viewed by the recommender, a perfect or imperfect match of products of the at least one advertisement viewed by the recommender and the transactions of the cluster, and a time frame between the at least one advertisement for the product viewed by the recommender and the transaction for the product by the cluster for the product of the advertisement viewed by the recommender

15. A computer-implemented method for advertisement diffusion presentment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
identifying a network of individuals, wherein the network of individuals have a common interest in a product category;
identifying one or more individuals as recommenders within the network of individuals, wherein the recommender is identified as having influence over one or more clusters of individuals in the network for the product category;
receiving advertisements for the product category;
matching, via a computer device processor, one or more of the received advertisements to a recommender based at least in part on the influence of the recommenders for the product category of the one or more of the received advertisements;
presenting the advertisement to the recommender and not to the cluster;
receiving transaction data associated with transactions completed by the recommender and the cluster;
matching the merchant, product, and/or service of the one or more advertisements presented to the recommender to transactions completed by the cluster; and
providing advertising effectiveness data for advertisement diffusion through the network, based on the match.

16. The computer-implemented method of claim 15, wherein identifying the network of individuals, including identifying the recommender and the cluster further comprise using transaction history, coincident mapping, or social network mapping to identify the network of individuals, wherein transaction history identifies similar transactions for a category of products, coincided mapping maps likely association of individuals based on a category of products, and social networking mapping identifies a network of individuals associated with each other.

17. The computer-implemented method of claim 15 further comprises determining the recommender's influence on the network based on a number of individuals identified in the cluster around the recommender and the recommender's experience with products of the category of products.

18. The computer-implemented method of claim 15, wherein receiving advertisements for the product category further comprises determining a potential value for indirect presentation effectiveness of the advertisements based at least in part on advertisement contents, wherein advertisement contents comprises a simplicity of advertisement, such that the recommender can communicate contents of the advertisement to the network.

19. The computer-implemented method of claim 15, wherein matching the merchant, product, and/or service of the one or more advertisements presented to the recommender to transactions completed by the cluster further comprises identifying perfect matches and imperfect matches, wherein perfect matches are a same merchant, product, and/or service associated with a transaction of the network and the advertisement viewed by the recommender and imperfect matches are a similar merchant, product, and/or service of a customer transaction and the at least one advertisement viewed by the recommender.

20. The computer-implemented method of claim 15, wherein matching the merchant, product, and/or service of the one or more advertisements presented to the recommender to transactions completed by the cluster further identifies diffusion of the advertisement from the recommender to the cluster based on only the recommender viewing the advertisement.

21. The computer-implemented method of claim 15, wherein providing advertising effectiveness data for advertisement diffusion through the network further comprises providing a confidence associated with a success of the at least one advertisement diffusion through the network based on a likelihood that the at least one advertisement was viewed by the recommender, a perfect or imperfect match of products of the at least one advertisement viewed by the recommender and the transactions of the cluster, and a time frame between the at least one advertisement for the product viewed by the recommender and the transaction for the product by the cluster for the product of the advertisement viewed by the recommender.
